(19) United States
(12) Patent Application Publication
(10) Pub. No.: US 2023/0418710 A1
(43) Pub. Date: Dec. 28, 2023

(54) INFORMATION PROCESSING APPARATUS, AND CONTROL METHOD

(71) Applicant: Lenovo (Singapore) Pte. Ltd., Singapore (SG)

(72) Inventors: Ryo Fukuda, Kanagawa (JP); Naoyuki Araki, Kanagawa (JP); Ken Sasaki, Kanagawa (JP); Masatomo Mitamura, Kanagawa (JP)

(73) Assignee: Lenovo (Singapore) Pte. Ltd., Singapore (SG)

(21) Appl. No.: 18/306,233

(22) Filed: Apr. 24, 2023

(30) Foreign Application Priority Data
Jun. 23, 2022 (JP) 2022-100814

(51) Int. Cl. G06F 11/14; G06F 9/4401; G06F 11/22

(52) U.S. Cl. CPC G06F 11/142; G06F 9/4403; G06F 11/2284; G06F 2201/865

(57) ABSTRACT

An information processing apparatus includes a reference POST time storage which stores module identification information for identifying a module indicative of a partial function of the BIOS, and a reference value of a POST time indicative of processing time required in POST processing for the module in association with each other; and a BIOS processor which executes processing based on the BIOS, where the BIOS processor executes POST processing for the module as each of modules according to a setup configuration of the BIOS to execute processing for measuring the POST time for each executed module, and processing for determining whether or not the POST time is increasing based on the POST time measured for the module and the reference value corresponding to the module identification information of the module stored in the reference POST time storage unit to identify an abnormal module as the module having an abnormality.

### CROSS-REFERENCE TO RELATED APPLICATIONS

This application claims priority to Japanese Patent Application No. 2022-100814 filed on Jun. 23, 2022, the contents of which are hereby incorporated herein by reference in their entirety.

### BACKGROUND OF THE INVENTION

### Field of the Invention

The present invention relates to an information processing apparatus and a control method.

### Description of the Related Art

Conventionally, in an information processing apparatus such as a personal computer (PC), a BIOS (Basic Input Output System) is executed to initialize the information processing apparatus and boot an OS (Operating System). Further, in the conventional information processing apparatus, a diagnostic test called POST (Power-On Self-Test) processing is executed when booting by executing the BIOS.

### PATENT DOCUMENT

[Patent Document 1] Japanese Unexamined Patent Application Publication No. 2014-010492

In the meantime, in the information processing apparatus, POST processing is executed on modules in a BIOS according to the setup configuration of the BIOS, but POST time as a period of the POST processing may be longer due to deterioration or failure of a device built in the information processing apparatus. However, in the conventional information processing apparatus, when the POST time thus becomes longer, it is difficult to identify a module in which the POST time became longer and to estimate the cause of an abnormality.

### SUMMARY OF THE INVENTION

The present invention provides an information processing apparatus and a control method capable of identifying an abnormal part properly upon booting by a BIOS.

An information processing apparatus according to one aspect of the present invention includes: a reference POST time storage unit which stores module identification information for identifying a module indicative of a partial function of a BIOS (Basic Input Output System), and a reference value of a POST time indicative of processing time required in POST (Power-On Self-Test) processing for the module in association with each other; and a BIOS processing unit which executes processing based on the BIOS, where the BIOS processing unit executes the POST processing for the module as each of modules according to a setup configuration of the BIOS to execute processing for measuring the POST time for each executed module, and processing for determining whether or not the POST time is increasing based on the POST time measured for the module and the reference value corresponding to the module identification information of the module stored in the reference POST time storage unit to identify an abnormal module as the module having an abnormality.

The above information processing apparatus according to the one aspect of the present invention may also be such that, when the module is identified to have an abnormality, the BIOS processing unit classifies the abnormal module into a category based on either a gradual increase in which the POST time gradually increased or a rapid increase in which the POST time rapidly increased, and to which of software or hardware the module is related, and estimates a cause of the abnormality based on the classified category.

The above information processing apparatus according to the one aspect of the present invention may further be such that the BIOS processing unit determines whether the POST time is either the gradual increase or the rapid increase based on a difference value between the POST time measured this time and the POST time measured last time, and an average value of past difference values.

The above information processing apparatus according to the one aspect of the present invention may also include a change history storage unit which stores a change history related to changes in environment of the BIOS including a setup configuration change of the BIOS and a change in built-in device, wherein the BIOS processing unit acquires the change history related to the abnormal module from the change history storage unit, and estimates the cause of the abnormality based on the change history related to the abnormal module and the category.

The above information processing apparatus according to the one aspect of the present invention may further include a coping processing storage unit which stores the category, the cause of the abnormality, and coping processing information indicative of coping processing in association with one another, wherein the BIOS processing unit acquires, from the coping processing storage unit, the coping processing information corresponding to the category and the cause of the abnormality, and executes coping processing based on the acquired coping processing information.

Further, the above information processing apparatus according to the one aspect of the present invention may be such that, in the coping processing information, rollback processing information indicative of rollback processing for rolling back the environment of the BIOS to that before change is included, and when the coping processing information corresponding to the category and the cause of the abnormality is the rollback processing information, the BIOS processing unit executes the rollback processing based on the rollback processing information.

Further, the above information processing apparatus according to the one aspect of the present invention may be such that, in the coping processing information, recovery processing information indicative of recovery processing for recovering the environment of the BIOS is included, and when the coping processing information corresponding to the category and the cause of the abnormality is the recovery processing information, the BIOS processing unit executes the recovery processing based on the recovery processing information.

Further, a control method according to another aspect of the present invention is a control method of an information processing apparatus including: a reference POST time storage unit which stores module identification information for identifying a module indicative of a partial function of a BIOS (Basic Input Output System), and a reference value of a POST time indicative of processing time required in POST (Power-On Self-Test) processing for the module in association with each other; and a BIOS processing unit which executes processing based on the BIOS, the control method including: a step of causing the BIOS processing unit to execute the POST processing for the module as each of modules according to a setup configuration of the BIOS to measure the POST time for each executed module; and a step of causing the BIOS processing unit to determine whether or not the POST time is increasing based on the POST time measured for the module and the reference value corresponding to the module identification information of the module stored in the reference POST time storage unit in order to identify an abnormal module as the module having an abnormality.

The above-described aspects of the present invention can identify an abnormal part properly upon booting by a BIOS.

### BRIEF DESCRIPTION OF THE DRAWINGS

FIG. 1 is a diagram illustrating an example of the main hardware configuration of a laptop PC according to one or more embodiments.

FIG. 2 is a functional block diagram illustrating an example of the functional configuration of the laptop PC according to the one or more embodiments.

FIG. 3 is a table illustrating a data example of a reference POST time storage unit in the one or more embodiments.

FIG. 4 is a table illustrating a data example of a BIOS change history storage unit in the one or more embodiments.

FIG. 5 is a table illustrating a data example of a measured POST time storage unit in the one or more embodiments.

FIG. 6 is a table illustrating a data example of a difference value storage unit in the one or more embodiments.

FIG. 7 is a table illustrating a data example of a determination condition information storage unit in the one or more embodiments.

FIG. 8 is a table illustrating a data example of an action information storage unit in the one or more embodiments.

FIG. 9 is a graph illustrating an example of a rapid increase in POST time in the one or more embodiments.

FIG. 10 is a graph illustrating a gradual increase in POST time in the one or more embodiments.

FIG. 11 is a flowchart illustrating the operation of the laptop PC according to the one or more embodiments.

### DETAILED DESCRIPTION OF THE INVENTION

An information processing apparatus and a control method according to one or more embodiments of the present invention will be described below with reference to the accompanying drawings.

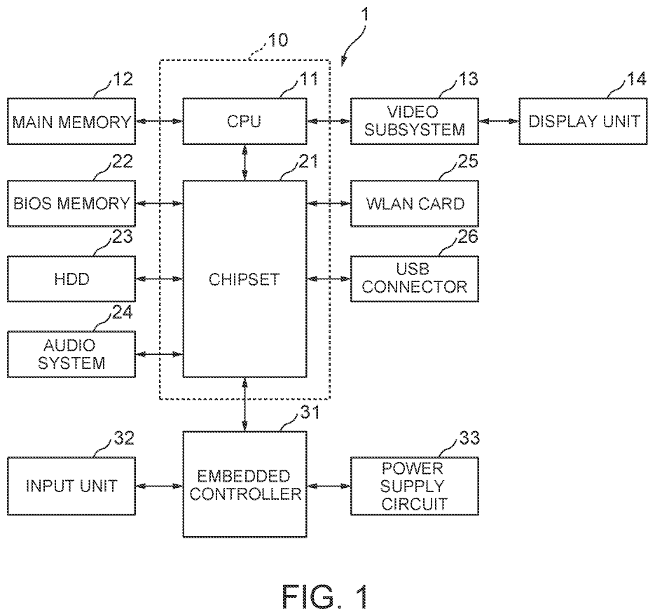

FIG. 1 is a diagram illustrating an example of the main hardware configuration of a laptop PC 1 according to the one or more embodiments. Note that the laptop PC 1 is described as an example of an information processing apparatus in the one or more embodiments.

As illustrated in FIG. 1, the laptop PC 1 includes a CPU 11, a main memory 12, a video subsystem 13, a display unit 14, a chipset 21, a BIOS memory 22, an HDD 23, an audio system 24, a WLAN card 25, a USB connector 26, an embedded controller 31, an input unit 32, and a power supply circuit 33.

In the one or more embodiments, note that the CPU 11 and the chipset 21 correspond to a main control unit 10. Further, the main control unit 10 is an example of a processor (main processor) to execute a program stored in a memory (main memory 12).

The CPU (Central Processing Unit) 11 executes various kinds of arithmetic processing under the control of the program to control the entire laptop PC 1.

The main memory 12 is a writable memory used as reading areas of execution programs of the CPU 11 or working areas to which processing data of the execution programs are written. The main memory 12 is composed, for example, of plural DRAM (Dynamic Random Access Memory) chips. The execution programs include a BIOS (Basic Input Output System), an OS, various drivers for hardware-operating peripheral devices, various services/utilities, application programs, and the like.

The video subsystem 13 is a subsystem for realizing a function related to image display, which includes a video controller. This video controller processes a drawing command from the CPU 11, writes processed drawing information into a video memory, and reads this drawing information from the video memory to output the drawing information to the display unit 14 as drawing data (display data).

For example, the display unit 14 is a liquid crystal display to display a display screen based on the drawing data (display data) output from the video subsystem 13.

The chipset 21 includes controllers such as USB (Universal Serial Bus), serial ATA (AT Attachment), an SPI (Serial Peripheral Interface) bus, a PCI (Peripheral Component Interconnect) bus, a PCI-Express bus, and an LPC (Low Pin Count) bus, and plural devices are connected thereto. In FIG. 1, as examples of devices, the BIOS memory 22, the HDD 23, the audio system 24, the WLAN card 25, and the USB connector 26 are connected to the chipset 21.

The BIOS memory 22 is configured, for example, by an electrically rewritable nonvolatile memory such as an EEPROM (Electrically Erasable Programmable Read Only Memory) or a flash ROM. The BIOS memory 22 stores system firmware for controlling the BIOS, the embedded controller 31, and the like.

The HDD (Hard Disk Drive) 23 (an example of a nonvolatile storage device) stores the OS, various drivers, various services/utilities, application programs, and various data.

The audio system 24 records, plays back, and outputs sound data.

The WLAN (Wireless Local Area Network) card 25 is connected to a network through wireless LAN to perform data communication.

The USB connector 26 is a connector for connecting peripheral devices using the USB.

The embedded controller 31 (an example of a sub-control unit) is a one-chip microcomputer which monitors and controls various devices (peripheral devices, sensors, and the like) regardless of the system state of the laptop PC 1. Further, the embedded controller 31 has a power management function to control the power supply circuit 33. Note that the embedded controller 31 is composed of a CPU, a ROM, a RAM, and the like, and includes multi-channel A/D input terminal and D/A output terminal, a timer, and digital input/output terminals, which are not illustrated. To the embedded controller 31, for example, the input unit 32, the power supply circuit 33, and the like are connected through these input/output terminals. The embedded controller 31 controls the operation of these units.

The input unit 32 is, for example, an input device such as a keyboard, a pointing device, or a touch pad.

The power supply circuit 33 includes, for example, a DC/DC converter, a charge/discharge unit, a buttery unit, an AC/DC adapter, and the like to convert DC voltage supplied from the AC/DC adapter or the battery unit into plural voltages required to operate the laptop PC 1. Further, the power supply circuit 33 supplies power to each unit of the laptop PC 1 under the control of the embedded controller 31.

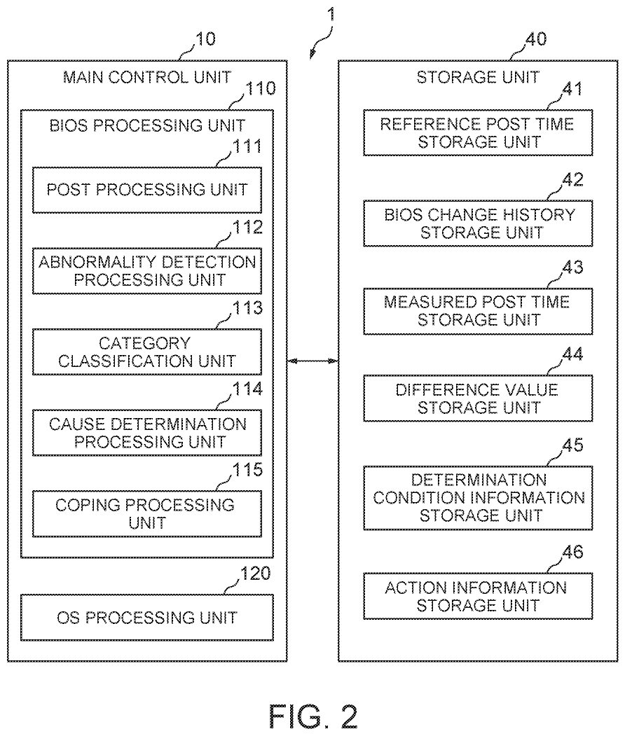

Referring next to FIG. 2, the functional configuration of the laptop PC 1 according to the one or more embodiments will be described.

FIG. 2 is a functional block diagram illustrating an example of the functional configuration of the laptop PC 1 according to the one or more embodiments. Note that only the configuration associated with the present invention is described in FIG. 2 among the functional components included in the laptop PC 1.

As illustrated in FIG. 2, the laptop PC 1 includes the main control unit 10 and a storage unit 40.

The storage unit 40 is, for example, a storage unit realized by the BIOS memory 22 to store information related to the BIOS. Note that it is assumed that the BIOS setup configuration is prestored in the storage unit 40.

Further, the storage unit 40 includes a reference POST time storage unit (reference POST time storage) 41, a BIOS change history storage unit 42, a measured POST time storage unit 43, a difference value storage unit 44, a determination condition information storage unit 45, and an action information storage unit 46.

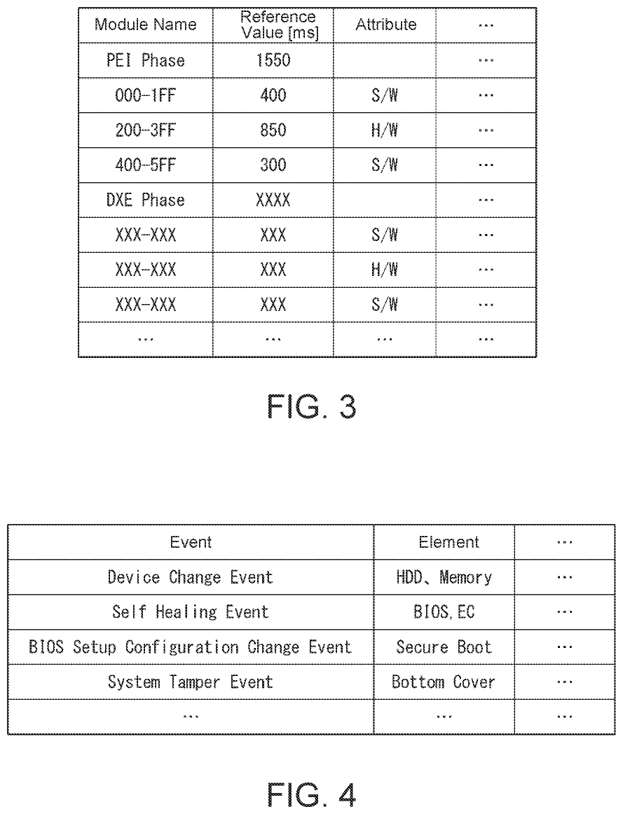

The reference POST time storage unit 41 is a storage unit realized by the BIOS memory 22, which stores a reference value of a POST time indicative of a processing time required in POST (Power-On Self-Test) processing by the BIOS. The reference value of the POST time is set based on the POST time measured at the factory shipment of the laptop PC 1. Referring here to FIG. 3, a data example of the reference POST time storage unit 41 will be described.

FIG. 3 is a table illustrating the data example of the reference POST time storage unit 41 in the one or more embodiments.

As illustrated in FIG. 3, the reference POST time storage unit 41 stores Module Name, Reference Value, and Attribute in association with one another.

Here, the module name indicates the name of each module indicative of a partial function of the BIOS. The module name is an example of module identification information for identifying each module.

Further, the reference value indicates a reference value of the POST time, which is set for each module based on the POST time measured at the factory shipment of the laptop PC 1. Note that the reference value is a value different for each individual laptop PC 1.

Further, the attribute is attribute information indicating whether the content of POST processing is related to software (S/W) or hardware (H/W).

In the example illustrated in FIG. 3, it is illustrated that the overall reference value of a module name of “PEI Phase” is “1550” (ms). Further, it is illustrated that the reference value of “000-1FF” in the module name of “PEI Phase” is “400” and the attribute is “S/W.” Further, it is illustrated that the reference value of “200-3FF” is “850” and the attribute is “H/W.”

Thus, the reference POST time storage unit 41 stores, for all modules, module identification information (module names) and reference values of POST times associated with each other.

Returning to the description of FIG. 2, the BIOS change history storage unit 42 (an example of a change history storage unit) is a storage unit realized by the BIOS memory 22, which stores a change history related to changes in the BIOS environment including BIOS setup configuration changes and changes in built-in devices (such as the CPU 11, the main memory 12, and the HDD 23). For example, the BIOS change history storage unit 42 stores event logs of changes in the BIOS setup configuration and changes in the built-in devices. Referring here to FIG. 4, a data example of the BIOS change history storage unit 42 will be described.

FIG. 4 is a table illustrating a data example of the BIOS change history storage unit 42 in the one or more embodiments.

As illustrated in FIG. 4, the BIOS change history storage unit 42 stores event logs in which each event and each element are associated with each other.

In FIG. 4, each event indicates the content of an event such as an executed change in the BIOS setup configuration or in a built-in device. Further, the element indicates an element related to the event. Note that the BIOS change history storage unit 42 stores event logs in chronological order.

In the example illustrated in FIG. 4, as a first event log, it is illustrated that an event log in which the event is “Device Change Event” and the element is “HDD, Memory.” Further, as the next event log, it is illustrated that the event is “Self Healing Event” and the element is “BIOS, EC.”

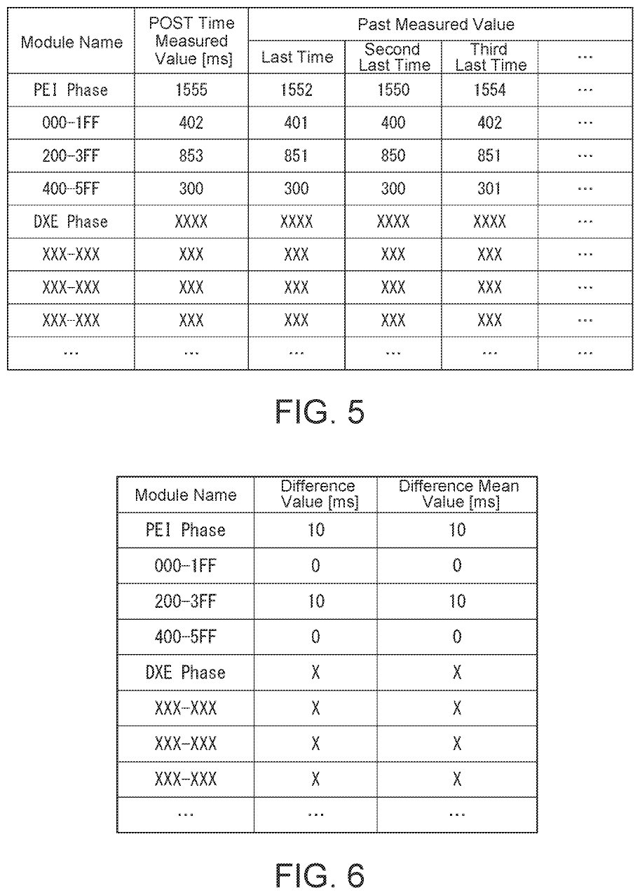

Returning to the description of FIG. 2 again, the measured POST time storage unit 43 is a storage unit realized by the BIOS memory 22 to store each of actually measured POST times. For example, the measured POST time storage unit 43 stores each module name and each POST time measured value in association with each other. Referring here to FIG. 5, a data example of the measured POST time storage unit 43 will be described.

FIG. 5 is a table illustrating a data example of the measured POST time storage unit 43 in the one or more embodiments.

As illustrated in FIG. 5, the measured POST time storage unit 43 stores each module name, each POST time measured value, and past measured values in association with one another.

In FIG. 5, the module name is an example of module identification information, the POST time measured value is a measured value of the POST time. Further, the past measured values indicate measured values of POST times measured a predetermined number of times in the past.

For example, in the example illustrated in FIG. 5, it is indicated that the measured value of the whole POST time of the module name of “PEI Phase” is “1555” (is), the last measured value is “1552” (is), the second last measured value is “1550” (is), and the third last measured value is “1554” (is) as the past measured values. Further, it is indicated that the measured value of the POST time in a “000-1FF” part is “402” (ns), and the last measured value is “401” (is), the second last measured value is “400” (is), and the third last measured value is “402” (is) as the past measured values.

Further, it is indicated that the measured value of the POST time in a “200-3FF” part is “853” (is), and the last measured value is “851” (is), the second last measured value is “850” (is), and the third last measured value is “851” (is) as the past measured values. Further, it is indicated that the measured value of the POST time in a “400-5FF” part is “300” (ns), and the last measured value is “300” (is), the second last measured value is “300” (is), and the third last measured value is “301” (is) as the past measured values.

Returning to the description of FIG. 2 again, the difference value storage unit 44 is a storage unit realized by the BIOS memory 22, which stores a difference value between the POST time measured this time and the POST time measured last time, and an average value of difference values measured a predetermined number of times. Referring here to FIG. 6, a data example of the difference value storage unit 44 will be described.

FIG. 6 is a table illustrating a data example of the difference value storage unit 44 in the one or more embodiments.

As illustrated in FIG. 6, the difference value storage unit 44 stores each module name, each difference value, and each difference mean value in association with one another.

In FIG. 6, the module name is an example of module identification information, and the difference value indicates a difference value between the POST time measured this time and the POST time measured last time. Further, the difference mean value indicates an average value of difference values measured a predetermined number of times in the past.

For example, in the example illustrated in FIG. 6, it is indicated that the difference value of the module name of “PEI Phase” is “10” (ns) and the difference mean value is “10” (ns). Further, it is indicated that the difference value in the “000-1FF” part is “0” (ns) and the difference mean value is “0” (ns).

Further, it is indicated that the difference value in the “200-3FF” part is “10” (ns) and the difference mean value is “10” (ns). Further, it is indicated that the difference value in the “400-5FF” part is “0” (ns) and the difference mean value is “0” (ns).

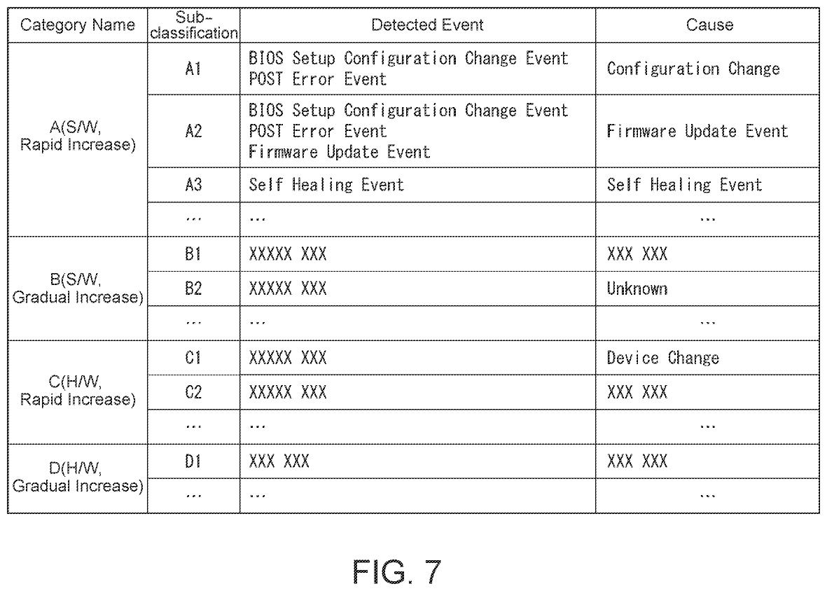

Returning to the description of FIG. 2 again, the determination condition information storage unit 45 is a storage unit realized by the BIOS memory 22, which stores cause determination conditions for abnormal modules in which POST times increased. For example, the determination condition information storage unit 45 stores each category in which each module whose abnormality is detected due to an increase in POST time is classified, and each cause estimated from each event log. It is assumed that information stored in the determination condition information storage unit 45 is prestored. Referring here to FIG. 7, a data example of the determination condition information storage unit 45 will be described.

FIG. 7 is a table illustrating a data example of the determination condition information storage unit 45 in the one or more embodiments.

As illustrated in FIG. 7, the determination condition information storage unit 45 stores each category name, each sub-classification, each detected event, and each cause in association with one another.

In FIG. 7, the category name indicates the classified category name, and the sub-classification indicates a sub-classification of the category. Note that the category details will be described later. Further, the detected event indicates an event most recently detected among event logs stored in the BIOS change history storage unit 42 described above. Further, the cause indicates an estimated cause of each abnormal module.

In the example illustrated in FIG. 7, it is indicated that, in a case of a category name of “A(S/W, Rapid Increase),” when the sub-classification is “A1” and the detected event is “BIOS Setup Configuration Change Event” and “POST Error Event,” the cause is “Configuration Change.”

Thus, the determination condition information storage unit 45 stores an estimated cause (the cause of increasing the POST time) of each detected event for each category.

Returning to the description of FIG. 2 again, the action information storage unit 46 (an example of a coping processing storage unit (coping processing storage)) is a storage unit realized by the BIOS memory 22, which stores an action table indicative of coping processing (action) for the cause of each abnormal module in which the POST time increased.

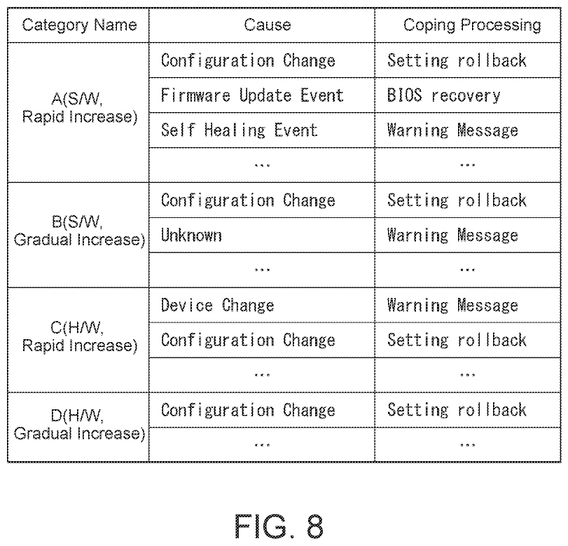

For example, the action information storage unit 46 stores each category, each cause of an abnormality, and coping processing information (action information) indicative of each coping processing (action) in association with one another. It is assumed that the information stored in the action information storage unit 46 is prestored. Referring here to FIG. 8, a data example of the action information storage unit 46 will be described.

FIG. 8 is a table illustrating a data example of the action information storage unit 46 in the one or more embodiments.

As illustrated in FIG. 8, the action information storage unit 46 stores each category name, each cause, and each coping processing in association with one another.

In FIG. 8, the category name is an example of category identification information for identifying each category. Further, the cause indicates an estimated cause of an abnormal module in which the POST time increased, and the coping processing indicates coping processing (action) on the cause.

In the example illustrated in FIG. 8, when the category name is “A(S/W, Rapid Increase)” and the cause is “Configuration Change,” it is indicated that the coping processing is “Setting rollback.” Further, when the category name is “A(S/W, Rapid Increase)” and the cause is “Firmware Update Event,” it is indicated that the coping processing is “BIOS recovery.”

Further, when the category name is “A(S/W, Rapid Increase)” and the cause is “Self Healing Event,” it is indicated that the coping processing is “Warning Message.”

Returning to the description of FIG. 2 again, the main control unit 10 is a functional unit implemented by causing the CPU 11 and the chipset 21 to execute programs stored in the BIOS memory 22 and the HDD 23, which executes various processing of the laptop PC 1 based on the BIOS or the OS. The main control unit 10 includes a BIOS processing unit (BIOS processor) 110 and an OS processing unit 120.

The BIOS processing unit 110 is a functional unit implemented by causing the CPU 11 and the chipset 21 to execute programs stored in the BIOS memory 22, which executes various processing based on the BIOS. For example, at the boot of the laptop PC 1, the BIOS processing unit 110 executes POST processing, and when the result is normal, the BIOS processing unit 110 boots the OS and hands over processing to the OS processing unit 120 to be described later.

Further, the BIOS processing unit 110 executes POST processing for each module according to the BIOS setup configuration, measures the POST time for each module executed, and identifies an abnormal module in which the POST time increased. Further, the BIOS processing unit 110 estimates a cause of the identified abnormal module in which the POST time increased, and executes coping processing on the estimated cause.

Further, the BIOS processing unit 110 includes a POST processing unit 111, an abnormality detection processing unit 112, a category classification unit 113, a cause determination processing unit 114, and a coping processing unit 115.

The POST processing unit 111 is a functional unit implemented by causing the CPU 11 and the chipset 21 to execute a program stored in the BIOS memory 22 to execute POST processing for each module according to the BIOS setup configuration in order to execute processing for measuring the POST time for each executed module. The POST processing unit 111 executes POST processing on each module upon the boot of the laptop PC 1, and stores, in the measured POST time storage unit 43, each module name, each POST time measured value, and the past measured values in association with one another, for example, as illustrated in FIG. 5. Note that the past measured values are, for example, measured values measured three times in the past before the measured value measured this time.

The abnormality detection processing unit 112 is a functional unit implemented by causing the CPU 11 and the chipset 21 to execute a program stored in the BIOS memory 22 to determine whether or not the POST time is increasing based on the POST time measured for the module and a reference value corresponding to module identification information of the module stored in the reference POST time storage unit 41 in order to execute processing for identifying an abnormal module as a module having an abnormality. Here, the abnormal module means a module determined to be abnormal due to the increase in POST time.

The abnormality detection processing unit 112 compares, for each module, the POST time stored in the measured POST time storage unit 43 and the reference value stored in the reference POST time storage unit 41 to determine whether or not the POST time is increasing. Specifically, the abnormality detection processing unit 112 determines, from Formula (1) below, whether or not the POST time is increasing depending on whether or not the measured value is equal to or more than a (reference value +α).

Measured value t≥Reference value t_{R}+α (1)

Note that “α” here is a predetermined margin value.

Further, the abnormality detection processing unit 112 identifies a module in which the POST time is determined to be increasing to be an abnormal module having an abnormality (problem).

The category classification unit 113 is a functional unit implemented by causing the CPU 11 and the chipset 21 to execute a program stored in the BIOS memory 22, which classifies abnormal modules into four categories below when the modules are identified to have abnormalities.
Category “A”: The POST time rapidly increases in terms of S/W (S/W, Rapid Increase)
Category “B”: The POST time gradually increases in terms of S/W (S/W, Gradual Increase)
Category “C”: The POST time rapidly increases in terms of H/W (H/W, Rapid Increase)
Category “D”: The POST time gradually increases in terms of H/W (H/W, Gradual Increase)

In other words, for example, based on whether the POST time is a gradual increase in which the POST time gradually increased or a rapid increase in which the POST time rapidly increased, and to which of software or hardware each module concerned is related, the category classification unit 113 classifies abnormal modules into categories.

The category classification unit 113 calculates a difference value Δt (=t_{N}−t_{N-1}) between the measured value t_{N} and the last measured value t_{N-1}. For example, the category classification unit 113 uses information stored in the measured POST time storage unit 43 to calculate the difference value Δt.

Further, the category classification unit 113 calculates a difference mean values using difference values Δt calculated multiple times in the past. The category classification unit 113 uses the information stored in the measured POST time storage unit 43 to calculate the difference mean value. Note that the category classification unit 113 calculates the difference value Δt and the difference mean value for each abnormal module, and stores the calculated difference value Δt and difference mean value in the difference value storage unit 44 in association with the module name.

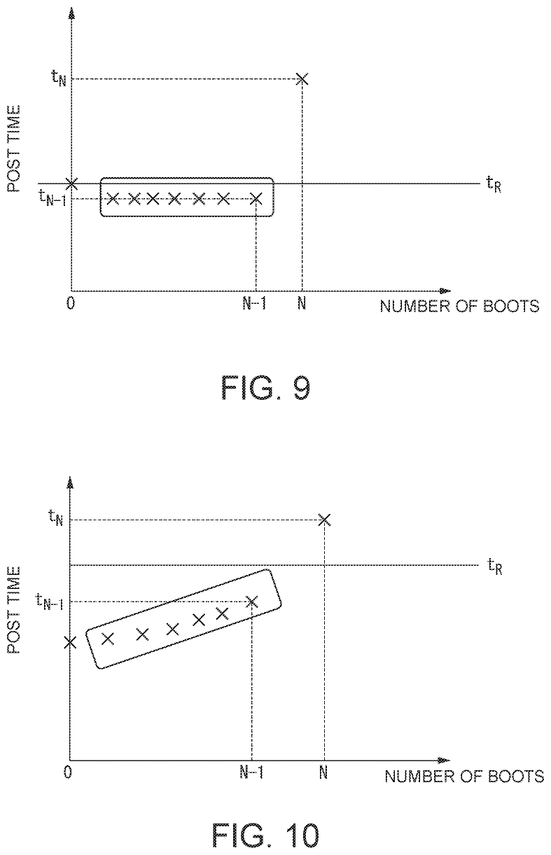

The category classification unit 113 compares the calculated difference value Δt and the difference mean value to distinguish whether the increase in the POST time is the rapid increase or the gradual increase. Referring here to FIG. 9, the determination of the rapid increase in POST time will be described.

FIG. 9 is a graph illustrating an example of the rapid increase of the POST time in the one or more embodiments.

In the graph of FIG. 9, the vertical axis indicates POST time and the horizontal axis indicates the number of boots. Further, “x” in the graph indicates each measured value of the POST time.

In the example illustrated in FIG. 9, an example in which the POST time (t_{N-1}) that was equal to or less than the reference value t_{R} until the (N−1)-th time but the POST time (t_{N}) exceeds the reference value t_{R} at the N-th time and determined to be an abnormal module is illustrated. In this example, a relationship between the difference value Δt_{N} and the difference mean value μ is expressed in Equation (2) below.

$$Difference Mean Value μ = \frac{1}{N} {\sum }_{1}^{N} Δ {t}_{n} ≪ Difference Value Δ {t}_{N} \qquad ( 2 )$$

In other words, when the difference value Δt_{N} is larger than the difference mean value μ (that is, when the slope changes abruptly from a certain slope (here “0”), the category classification unit 113 determines that the increase in the POST time is Rapid Increase.

Further, FIG. 10 is a graph illustrating an example of Gradual Increase in the POST time in the one or more embodiments.

In FIG. 10, the vertical axis of the graph indicates POST time and the horizontal axis indicates the number of boots. Further, “x” in the graph indicates each measured value of the POST time.

In the example illustrated in FIG. 10, an example in which the POST time (t_{N-1}) equal to or less than the reference value t_{R} is gradually increasing until the (N−1)-th time, but the POST time (t_{N}) exceeds the reference value t_{R} at the N-th time and determined to be an abnormal module is illustrated.

In this example, a relationship between the difference value Δt_{N} and the difference mean value μ is expressed in Equation (3) below.

$$Difference Mean Value μ = \frac{1}{N} {\sum }_{1}^{N} Δ {t}_{n} \approx Difference Value Δ {t}_{N} \qquad ( 3 )$$

In other words, when the difference value Δt_{N} is approximately equal to the difference mean value μ (that is, when the slope exceeds the reference value t_{R} while keeping constant at a certain slope), the category classification unit 113 determines that the increase in the POST time is Gradual Increase.

Further, the category classification unit 113 determines whether the module is related to either software or hardware depending on the attribute in the reference POST time storage unit 41 illustrated in FIG. 3.

The category classification unit 113 classifies the abnormal module into any one of the four categories of Category “A” to Category “D” described above depending on whether the abnormal module is the rapid increase or the gradual increase, and to which of software or hardware the abnormal module is related.

The cause determination processing unit 114 is a functional unit implemented by causing the CPU 11 and the chipset 21 to execute a program stored in the BIOS memory 22, which estimates the cause of an abnormality with increased POST time based on the category classified by the category classification unit 113. For example, the cause determination processing unit 114 acquires an event log (change history) related to the abnormal module from the BIOS change history storage unit 42, and determines the cause of the abnormality based on the category of the abnormal module and the event log.

For example, the cause determination processing unit 114 acquires a cause corresponding to the category name of the abnormal module and the detected event from the determination condition information storage unit 45 as illustrated in FIG. 7. For example, when the category name is “A(S/W, Rapid Increase)” and the detected event is “BIOS Setup Configuration Change Event” and “POST Error Event,” the cause determination processing unit 114 determines the cause of the abnormality is “Configuration Change” from the BIOS change history storage unit 42 illustrated in FIG. 7 described above.

The coping processing unit 115 is a functional unit implemented by causing the CPU 11 and the chipset 21 to execute a program stored in the BIOS memory 22, which executes coping processing (action) on the cause of the abnormality determined by the cause determination processing unit 114. The coping processing unit 115 acquires, from the action information storage unit 46, action information (coping processing information) corresponding to the category and the cause of the abnormality, and executes coping processing based on the acquired action information.

For example, in the action information, rollback processing information (for example, “Setting rollback”) indicative of rollback processing to roll back the BIOS environment to that before change. When the coping processing information corresponding to the category and the cause of the abnormality is rollback processing information, the coping processing unit 115 executes rollback processing based on the rollback processing information. Note that when the action information is “Setting rollback,” the coping processing unit 115 executes coping processing to roll back the BIOS setup configuration to the state before change.

Further, for example, in the action information, recovery processing information (for example, “BIOS recovery”) indicative of recovery processing to recover the BIOS environment is included. When the action information corresponding to the category and the cause of the abnormality is recovery processing information, the coping processing unit 115 executes recovery processing based on the recovery processing information. Note that when the action information is “BIOS recovery,” the coping processing unit 115 executes coping processing to recover the version of BIOS firmware (BIOS program) to the original version.

Further, for example, in the action information, message display processing information (for example, “Warning Message”) indicative of processing to display a message is included. When the action information corresponding to the category and the cause of the abnormality is message display processing information, the coping processing unit 115 executes message display processing based on the message display processing information. Note that when the action information is “Warning Message,” the coping processing unit 115 executes coping processing to display a warning message on the display unit 14.

The OS processing unit 120 is a functional unit implemented by causing the CPU 11 and the chipset 21 to execute programs stored in the BIOS memory 22, which executes processing based on the OS. The OS processing unit 120 executes processing of various application software and the like based on the OS.

Next, the operation of the laptop PC 1 according to the one or more embodiments will be described with reference to a drawing.

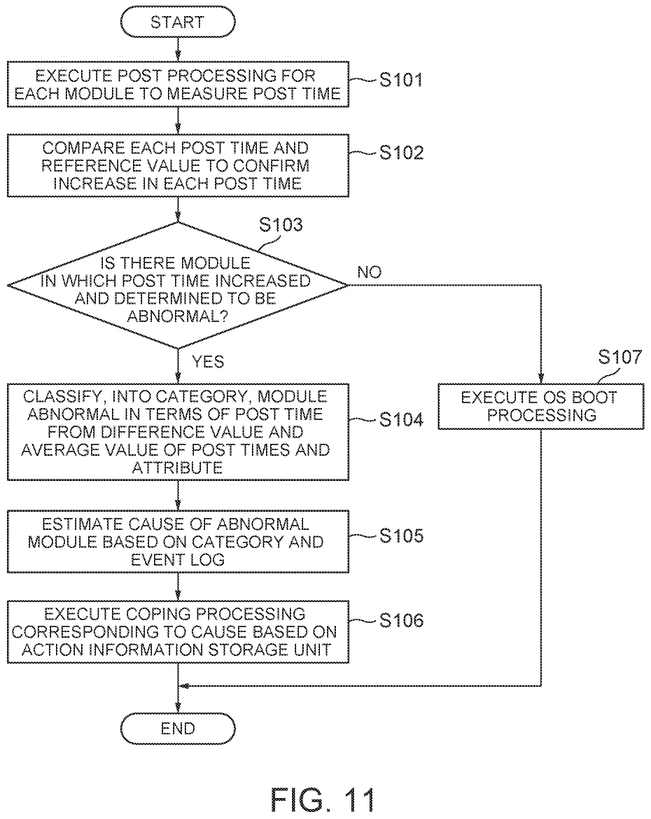

FIG. 11 is a flowchart illustrating an example of the operation of the laptop PC 1 according to the one or more embodiments. Here, the operation of abnormal cause identification processing due to an increase in POST processing at the boot of the laptop PC 1 and coping processing will be described.

As illustrated in FIG. 11, when the laptop PC 1 is powered on or reset, the BIOS processing unit 110 of the laptop PC 1 first executes POST processing for each module to measure the POST time (step S101). The POST processing unit 111 of the BIOS processing unit 110 executes the POST processing for each module according to the BIOS setup configuration to measure the POST time by using a timer, for example, built in the CPU 11 or the embedded controller 31. The POST processing unit 111 stores the measured value of the measured POST time in the measured POST time storage unit 43, for example, as illustrated in FIG. 5.

Next, the BIOS processing unit 110 compares each POST time and a reference value to confirm an increase in each POST time (step S102). The abnormality detection processing unit 112 of the BIOS processing unit 110 compares, for each module, the POST time stored in the measured POST time storage unit 43 and the reference value stored in the reference POST time storage unit 41 to determine whether the POST time is increasing or not. Specifically, the abnormality detection processing unit 112 determines whether the POST time is increasing or not based on whether or not the measured value is equal to or more than the (reference value +α) from Formula (1) described above.

Next, the abnormality detection processing unit 112 determines whether or not there is a module in which the POST time increased and determined to be abnormal (step S103). In other words, the abnormality detection processing unit 112 determines whether or not an abnormal module is detected. When an abnormal module is detected (step S103: YES), the abnormality detection processing unit 112 advances the processing to step S104. On the other hand, when any abnormal module is not detected (step S103: NO), the abnormality detection processing unit 112 advances the processing to step S107.

In step S104, the BIOS processing unit 110 classifies, into a category, a module abnormal in terms of the POST time (abnormal module) from the difference value Δt, the average value (difference mean value) of the POST times, and the attribute. The category classification unit 113 of the BIOS processing unit 110 uses Equation (2) and Equation (3) described above to determine whether the POST time is either the gradual increase in which the POST time gradually increased or the rapid increase in which the POST time rapidly increased.

Further, from the attribute in the reference POST time storage unit 41 illustrated in FIG. 3, the category classification unit 113 determines to which of software or hardware the module is related. Then, the category classification unit 113 classifies the abnormal module into any one of the four categories of Category “A” to Category “D” described above depending on the fact that the abnormal module is the rapid increase or the gradual increase, and that the abnormal module is related to which of software or hardware.

Next, the BIOS processing unit 110 estimates the cause of the abnormal module based on the category and the event log (step S105). For example, the cause determination processing unit 114 of the BIOS processing unit 110 acquires an event log (change history) related to the abnormal module from the BIOS change history storage unit 42, and determines the cause of the abnormality based on the category of the abnormal module and the event log.

Next, the BIOS processing unit 110 executes coping processing corresponding to the cause based on the action information storage unit 46 (step S106). The coping processing unit 115 of the BIOS processing unit 110 acquires action information (coping processing information) corresponding to the category and the cause of the abnormality from the action information storage unit 46, and executes coping processing based on the acquired action information. After the process in step S106, the BIOS processing unit 110 ends the processing.

Further, in step S107, the BIOS processing unit 110 executes OS boot processing. After the process in step S107, the BIOS processing unit 110 transfers the processing to the OS processing unit 120, and ends the boot processing by the BIOS.

As described above, the laptop PC 1 (information processing apparatus) according to the one or more embodiments includes the reference POST time storage unit 41 and the BIOS processing unit 110 to execute processing based on the BIOS. The reference POST time storage unit 41 stores module identification information (for example, a module name) for identifying a module indicative of a partial function of the BIOS, and a reference value of the POST time for the module in association with each other. The POST time indicates processing time required for POST processing. The BIOS processing unit 110 executes POST processing for each module according to the BIOS setup configuration, and based on processing for measuring the POST time for each executed module, the POST time measured for the module, and the reference value corresponding to module identification information of the module stored in the reference POST time storage unit 41, the BIOS processing unit 110 determines whether or not the POST time is increasing, and executes processing for identifying an abnormal module as a module having an abnormality.

Thus, since the laptop PC 1 according to the one or more embodiments can identify a module in which the POST time is increasing and having an abnormality based on the measured value of the POST time and the reference value, an abnormal part can be identified properly and automatically upon booting by the BIOS.

Further, in the one or more embodiments, when it is identified that there is an abnormality in a module, the BIOS processing unit 110 classifies the abnormal module into a category based on whether the POST time is either the gradual increase in which the POST time gradually increased or the rapid increase in which the POST time rapidly increased, and to which of software or hardware the module is related, and estimates the cause of the abnormality based on the classified category.

Thus, the laptop PC 1 according to the one or more embodiments can determine (estimate) the cause of the abnormality with increased POST time more properly by classifying the abnormal module into a category.

Further, in the one or more embodiments, the BIOS processing unit 110 determines whether the POST time is either the gradual increase or the rapid increase based on the difference value between the POST time measured this time and the POST time measured last time, and an average value of difference values in the past.

Thus, the laptop PC 1 according to the one or more embodiments can determine whether the POST time is either the gradual increase or the rapid increase more properly by using the difference value between the POST times, and the average value of the difference values in the past, and hence can classify the abnormal module into a category properly. Therefore, the laptop PC 1 according to the one or more embodiments can determine (estimate) the cause of the abnormality with increased POST time more precisely.

Further, the laptop PC 1 according to the one or more embodiments includes the BIOS change history storage unit 42 (change history storage unit) for storing a change history (event log) related to changes in BIOS environment including a change in BIOS setup configuration and a change in built-in device. The BIOS processing unit 110 acquires the change history (event log) related to the abnormal module from the BIOS change history storage unit 42, and estimates the cause of the abnormality based on the change history (event log) related to the abnormal module and the category.

Thus, the laptop PC 1 according to the one or more embodiments can determine (estimate) the cause of the abnormality with increased POST time more precisely in a simple way by using the change history (event log) in the BIOS change history storage unit 42 and the category.

Further, the laptop PC 1 according to the one or more embodiments includes the action information storage unit 46 (coping processing storage unit) for storing the category, the cause of the abnormality, and action information (coping processing information) indicative of coping processing in association with one another. The BIOS processing unit 110 acquires, from the action information storage unit 46, action information (coping processing information) corresponding to the category and the cause of the abnormality, and executes coping processing based on the acquired action information (coping processing information).

Thus, for example, when the POST time increased due to deterioration or failure of a built-in device, the laptop PC 1 according to the one or more embodiments can execute coping processing automatically to carry out recovery.

Further, in the one or more embodiments, rollback processing information indicative of rollback processing for rolling back the BIOS environment to that before change is included in the action information (coping processing information). When the action information (coping processing information) corresponding to the category and the cause of the abnormality is rollback processing information, the BIOS processing unit 110 executes rollback processing based on the rollback processing information.

Thus, the laptop PC 1 according to the one or more embodiments can automatically execute repairing (recovery) by the rollback processing and hence can improve reliability.

Further, in the one or more embodiments, recovery processing information indicative of recovery processing for recovering the BIOS environment is included in the action information (coping processing information). When the coping processing information corresponding to the category and the cause of the abnormality is recovery processing information, the BIOS processing unit 110 executes recovery processing based on the recovery processing information.

Thus, the laptop PC 1 according to the one or more embodiments can automatically execute repairing (recovery) by the recovery processing and hence can improve reliability.

Further, a control method according to the one or more embodiments is a control method of the laptop PC 1 including: the reference POST time storage unit 41 which stores module identification information for identifying a module indicative of a partial function of the BIOS, and a reference value of a POST time indicative of processing time required in POST processing for the module in association with each other; and the BIOS processing unit 110 which executes processing based on the BIOS, the control method including a POST time measurement step and an abnormality identification step. In the POST time measurement step, the BIOS processing unit 110 executes POST processing for each module according to the BIOS setup configuration to measure the POST time for each executed module. In the abnormality identification step, the BIOS processing unit 110 determines whether or not the POST time is increasing based on the POST time measured for the module and the reference value corresponding to the module identification information of the module stored in the reference POST time storage unit 41 in order to identify an abnormal module as a module having an abnormality.

Thus, the control method according to the one or more embodiments has the same effect as the laptop PC 1 described above, and hence can identify an abnormal part properly and automatically upon booting by the BIOS.

Further, the laptop PC 1 (information processing apparatus) according to the one or more embodiments includes the reference POST time storage unit 41, a memory (for example, the main memory 12) for temporarily storing a program, and a processor (for example, the main control unit 10) which executes the program stored in the memory. The reference POST time storage unit 41 stores module identification information (for example, a module name) for identifying a module indicative of a partial function of the BIOS, and a reference value of the POST time for the module in association with each other. The POST time indicates processing time required for POST processing. The processor is configured to execute the program stored in the memory to perform BIOS processing. The processor executes POST time measurement processing and abnormality identification processing in the BIOS processing. As the POST time measurement processing, the processor executes the POST processing for each module according to the BIOS setup configuration and processing for measuring the POST time for each executed module. Further, as the abnormality identification processing, the processor executes processing for determining whether or not the POST time is increasing based on the POST time measured for the module and the reference value corresponding to module identification information of the module stored in the reference POST time storage unit 41 to identify an abnormal module as a module having an abnormality.

Thus, the laptop PC 1 according to the one or more embodiments can identify an abnormal part properly and automatically upon booting by the BIOS.

Note that the present invention is not limited to the aforementioned one or more embodiments, and changes can be made without departing from the scope of the present invention.

For example, in the aforementioned one or more embodiments, the example in which the information processing apparatus is the laptop PC 1 is described, but the present invention is not limited to this example, and the information processing apparatus may also be any other information processing apparatus such as a tablet terminal or a desktop PC.

Further, in the aforementioned one or more embodiments, the example in which the BIOS processing unit 110 performs coping processing on an abnormal module is described, but the present invention is not limited to this example, and the coping processing may be performed until the cause of the abnormality is estimated (determined).

Further, in the aforementioned one or more embodiments, the example in which POST processing, processing for detecting an increase in POST time, processing for estimating an abnormality cause, and coping processing are executed by the BIOS processing unit 110 at the boot of the laptop PC 1 is described, but the present invention is not limited to this example. These processing may also be executed, for example, from a BIOS setup configuration menu.

Further, in the aforementioned one or more embodiments, the coping processing (action) for the abnormal module is not limited to those described above, and any other coping processing (action) may also be executed.

Note that the laptop PC 1 described above has a computer system therein. Then, a program for implementing the function of each component included in the laptop PC 1 described above may be recorded on a computer-readable recording medium so that the program recorded on this recording medium is read into the computer system and executed to perform processing in each component included in the laptop PC 1 described above. Here, the fact that “the program recorded on the recording medium is read into the computer system and executed” includes installing the program on the computer system. It is assumed that the “computer system” here includes the OS and hardware such as peripheral devices and the like.

Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the laptop PC 1, or delivery servers for delivering respective divided pieces of the program may be different from one another. Further, it is assumed that the “computer-readable recording medium” includes a medium on which the program is held for a given length of time, such as a volatile memory (RA) inside a computer system as a server or a client when the program is transmitted through a network. Further, the above-mentioned program may also be to implement some of the functions described above. Further, the program may be a so-called differential file (differential program) capable of implementing the above-described functions in combination with a program(s) already recorded in the computer system.

Further, some or all of the functions described above may be realized as an integrated circuit such as LSI (Large Scale Integration). Each function described above may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 laptop PC
10 main control unit
11 CPU
12 main memory
13 video subsystem
14 display unit
21 chipset
22 BIOS memory
23 HDD
24 audio system
25 WLAN card
26 USB connector
31 embedded controller (EC)
32 input unit
33 power supply circuit
40 storage unit
41 reference POST time storage unit
42 BIOS change history storage unit
43 measured POST time storage unit
44 difference value storage unit
45 determination condition information storage unit
46 action information storage unit
110 BIOS processing unit
111 POST processing unit
112 abnormality detection processing unit
113 category classification unit
114 cause determination processing unit
115 coping processing unit
120 OS processing unit

What is claimed is:

1. An information processing apparatus comprising:
a reference POST time storage which stores module identification information for identifying a module indicative of a partial function of a BIOS (Basic Input Output System), and a reference value of a POST time indicative of processing time required in POST (Power-On Self-Test) processing for the module in association with each other; and
a BIOS processor which executes processing based on the BIOS, where the BIOS processor executes POST processing for the module as each of modules according to a setup configuration of the BIOS to execute:
processing for measuring the POST time for each executed module; and
processing for determining whether or not the POST time is increasing based on the POST time measured for the module and the reference value corresponding to the module identification information of the module stored in the reference POST time storage to identify an abnormal module as the module having an abnormality.

2. The information processing apparatus according to claim 1, wherein when the module is identified to have an abnormality, the BIOS processor classifies the abnormal module into a category based on either a gradual increase in which the POST time gradually increased or a rapid increase in which the POST time rapidly increased, and to which of software or hardware the module is related, and estimates a cause of the abnormality based on a classified category.

3. The information processing apparatus according to claim 2, wherein the BIOS processor determines whether the POST time is either the gradual increase or the rapid increase based on a difference value between the POST time measured this time and the POST time measured last time, and an average value of past difference values.

4. The information processing apparatus according to claim 2, further comprising
a change history storage which stores a change history related to changes in environment of the BIOS including a setup configuration change of the BIOS and a change in built-in device,
wherein the BIOS processor acquires the change history related to the abnormal module from the change history storage, and estimates the cause of the abnormality based on the change history related to the abnormal module and the category.

5. The information processing apparatus according to claim 4, further comprising
a coping processing storage which stores the category, the cause of the abnormality, and coping processing information indicative of coping processing in association with one another,
wherein the BIOS processor acquires, from the coping processing storage, the coping processing information corresponding to the category and the cause of the abnormality, and executes coping processing based on the acquired coping processing information.

6. The information processing apparatus according to claim 5, wherein
in the coping processing information, rollback processing information indicative of rollback processing for rolling back the environment of the BIOS to that before change is included, and
when the coping processing information corresponding to the category and the cause of the abnormality is the rollback processing information, the BIOS processor executes the rollback processing based on the rollback processing information.

7. The information processing apparatus according to claim 5, wherein
in the coping processing information, recovery processing information indicative of recovery processing for recovering the environment of the BIOS is included, and
when the coping processing information corresponding to the category and the cause of the abnormality is the recovery processing information, the BIOS processor executes the recovery processing based on the recovery processing information.

8. A control method of an information processing apparatus including: a reference POST time storage which stores module identification information for identifying a module indicative of a partial function of a BIOS (Basic Input Output System), and a reference value of a POST time indicative of processing time required in POST (Power-On Self-Test) processing for the module in association with each other; and a BIOS processor which executes processing based on the BIOS, the control method comprising:
a step of causing the BIOS processor to execute POST processing for the module as each of modules according to a setup configuration of the BIOS to measure the POST time for each executed module; and
a step of causing the BIOS processor to determine whether or not the POST time is increasing based on the POST time measured for the module and the reference value corresponding to the module identification information of the module stored in the reference POST time storage in order to identify an abnormal module as the module having an abnormality.
